(19) United States
(12) Patent Application Publication
(10) Pub. No.: US 2010/0010890 A1
(43) Pub. Date: Jan. 14, 2010

(54) Method and System for Measuring Advertisement Dwell Time

(75) Inventors: Gil Ditkovski, Moshav Mazor (IL); Dean Donaldson, Worthing (GB)

Correspondence Address: MYERS WOLIN, LLC, 100 HEADQUARTERS PLAZA, North Tower, 6th Floor, MORRISTOWN, NJ, 07960-6834, US

(73) Assignee: EYEBLASTER, LTD., Raanana (IL)

(21) Appl. No.: 12/493,733

(22) Filed: Jun. 29, 2009

Related U.S. Application Data
(60) Provisional application No. 61/129,482, filed on Jun. 30, 2008.

(51) Int. Cl. G06Q 30/00

(52) U.S. Cl. 705/14.41

(57) ABSTRACT

A method and system for measuring online advertisement dwell time. The method comprises monitoring a plurality of events being generated in a response to a user interaction with the online advertisement embedded in the webpage; determining at least a type of each event being monitored; instructing a counter adapted to count the dwell time to perform at least terminating the counting, starting the counting or stopping the counting; and recording a value of the counter as a measured dwell time, upon termination of the counting.

### CROSS-REFERENCE TO RELATED APPLICATIONS

This application claims the benefit of U.S. provisional application No. 61/129,482 filed on Jun. 30, 2008, the contents of which are herein incorporated by reference.

### FIELD OF THE INVENTION

The present invention relates generally to advertising over the Internet, and more particularly to techniques for measuring the time that users interact with advertisements on the Internet.

### BACKGROUND OF THE INVENTION

Interactive forms of media, such as provided on the Internet, have become widespread. Initially, the major advertising form on the Internet was based on banner advertising, which generally promotes a specific vendible product. When the banner is clicked upon, the user is linked to the advertiser's site, where more detailed information is provided about the products or services. Fundamentally, the banner advertisement competes for the viewers' attention with the other material provided on the site.

To attract users advertisement banners are now created to include rich media content, where the creative information is typically displayed as a combination of text, audio, still images, animation, video, and interactivity content forms. Different content types may be different objects of a rich-media advertisement. Rich media content can be downloadable or may be embedded in a webpage and can be viewed using a media player. The media player may be a plug-in or an offline application. A prime example for a rich media format and player is Flash provided by Adobe®.

Advertisement agencies try to measure the exposure of users to online advertisements when they launch marketing campaigns. Such a measure is typically used as one of the parameters for determining a price to pay for online advertising space. Additionally, such a measure would help advertisement agencies to determine the effectiveness of their advertisements and improve online advertisements that do not draw much attraction. With this aim, a few approaches have been developed to measure the exposure to online advertisements. A well-known approach is to count the number of entries to a web page on which an online advertisement is displayed. However, this metric is not accurate as users my browser the page without paying any attention to the advertisement. Another approach is to count the number of “clicks”, i.e., the number of times that users click upon an advertisement. This approach does not gauge the actual time that a user spent viewing the advertisement.

Other approaches include measuring dwell time by a user on an online advertisement by counting the amount of time that a user's pointing device (e.g., a mouse) was over the online advertisement. A major drawback of the conventional dwell time measurement is that there is no satisfactory way to count and measure the time that users interact with online advertisements. For example, a user may accidently cross over the advertisement using his/her mouse causing the conventional dwell approach to count the “exposure” time, even though the user has no interest in the offering of the advertisement. Another drawback of conventional dwell time measurements is that they are incapable of measuring the interaction with rich-media advertisements. As mentioned above, such advertisements may include different objects, the interaction with each such object may be triggered and measured separately.

Therefore, it would be advantageous to provide an efficient solution for accurately measuring the dwell time by a user interacting with online advertisements.

### SUMMARY OF THE INVENTION

Certain embodiments of the invention include a method for measuring online advertisement dwell time, wherein the method is performed by a client device adapted to download a webpage that includes the online advertisement. The method comprises monitoring a plurality of events being generated in a response to a user interaction with the online advertisement embedded in the webpage; determining at least a type of each event being monitored; instructing a counter adapted to count the dwell time to perform at least terminating the counting, starting the counting or stopping the counting; and recording a value of the counter as a measured dwell time, upon termination of the counting.

Certain embodiments of the invention further include a dwell counter for measuring online advertisement dwell time. The dwell counter comprises a plurality of event monitors for monitoring and capturing events associated with a user interaction with one or more rich-media objects of the online advertisement; a dwell controller for instructing a counter to perform at least terminating the counting, starting the counting or stopping the counting; and a counter for counting the dwell time based on instructions received from the dwell controller.

### BRIEF DESCRIPTION OF THE DRAWINGS

The subject matter that is regarded as the invention is particularly pointed out and distinctly claimed in the claims at the conclusion of the specification. The foregoing and other objects, features and advantages of the invention will be apparent from the following detailed description taken in conjunction with the accompanying drawings.

FIG. 1 is a diagram illustrating a network system utilized to describe the principles of the invention.

FIG. 2 is a block diagram of a dwell timer for measuring online advertisement dwell time constructed in accordance with an embodiment of the invention.

FIG. 3 is a flowchart describing a method for measuring online advertisement dwell time implemented in accordance with an embodiment of the invention.

FIG. 4 is a diagram of a state machine describing how events control the measuring process as implemented in accordance with an embodiment of the invention.

### DETAILED DESCRIPTION OF THE INVENTION

The embodiments disclosed by the invention are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

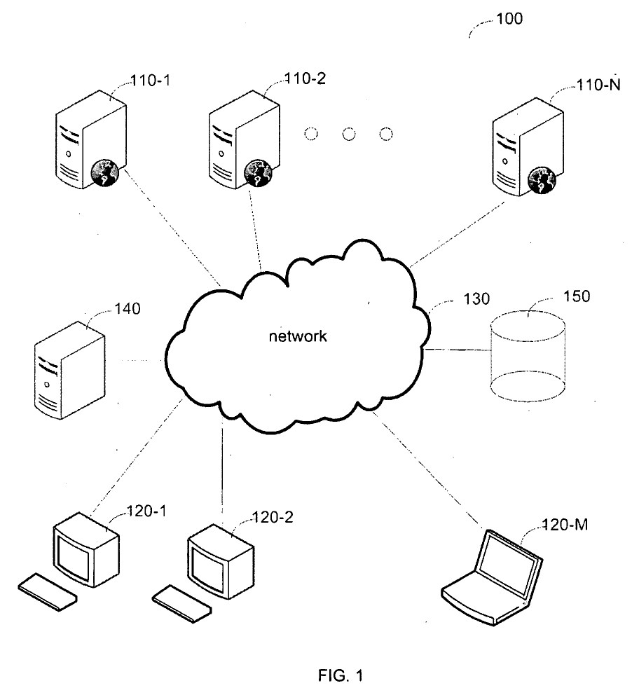

FIG. 1 shows an exemplary illustration of a network system 100 utilized to describe the principles of the invention. The network system 100 includes a plurality of servers 110-1 through 110-N (collectively referred to as “server 110”) and clients 120-1 through 120-M (collectively referred to as “client 120”) that communicate through a network 130, for example, a wide area network (WAN), that enables a connectivity such as Internet connectivity, and further including at least one publisher server 140. The network system 100 also includes a database 150 for storing dwell time measures received from clients 120. A client 120 comprises a pointing device (not shown), such as a mouse and a web browser, such as Microsoft® Internet Explorer® allowing the user to view and navigate through web pages downloaded from one or more servers 110 and/or server 140.

The publisher server 140 is connected to the WAN 130 and is capable of embedding online advertisements in web pages downloaded from servers 110 and further uploading web pages with advertisements to clients' 120 web browsers. Online advertisements are provided to the publisher server 140 by advertisement agencies. An online advertisement embedded in a webpage, by the publisher server 140, is adapted to cause a dwell timer to execute a process for measuring the dwell time by users on the online advertisement, when the web page is fully uploaded to a client 120. The dwell timer may be implemented as executable code (e.g., a script) and/or a firmware stored in a readable medium in the client 120, hardware, or any combination thereof. The dwell timer is executed over the client 120, which maybe any computing device including at least a processor and a computer readable medium.

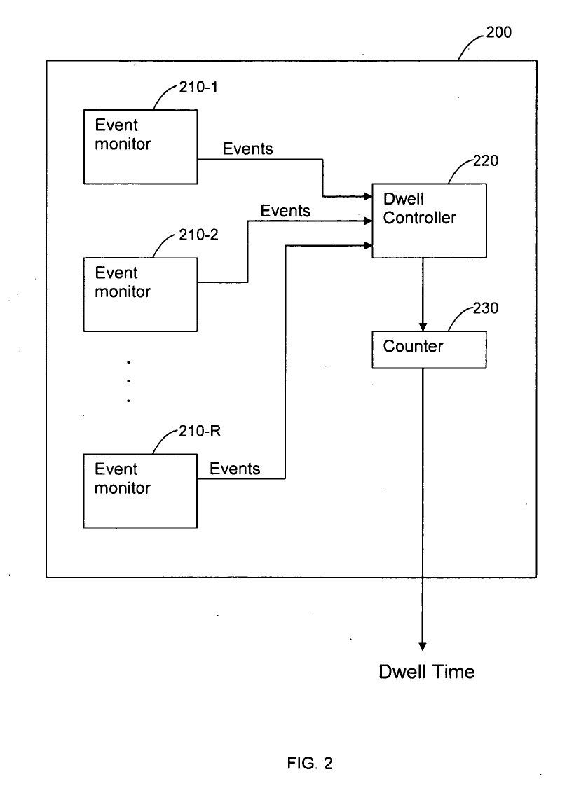

FIG. 2 shows a non-limiting and exemplary block diagram of a dwell timer 200 utilized to measure advertisement dwell time implemented in accordance with an embodiment of the invention. The dwell timer 200 includes a plurality of event monitors 210-1 through 210-R (collectively referred to as “event monitor 210”), a dwell controller 220, and a counter 230. In one embodiment, there is one counter 230 for each online advertisement embedded in the web page

Each event monitor 210 is capable of monitoring and capturing events associated with the interaction of a user with one or more rich-media objects of the online advertisement. In a preferred embodiment of the event, the event monitors 210 capture events including, but not limited to, the location of a pointing device on the webpage with respect to the advertisement (e.g., a mouse is over the advertisement), a state of a video clip being played in the advertisement (e.g., played, pause, replayed, etc.), a state of a panel in the advertisement (e.g., a panel is opened or closed), and so on. Other types of events that can be collected by the various event monitors 210 would be apparent to one of ordinary skill in the art. A panel is a rich media object embedded in the advertisement in which content can be displayed. For example, a panel can display video clips or provide additional information to the user. An event monitor 210 may be registered to a document object model (DOM) object of the HTML to capture events generated thereon. An event monitor 210 may also be coded as part of the rich media objects residing in the online advertisement.

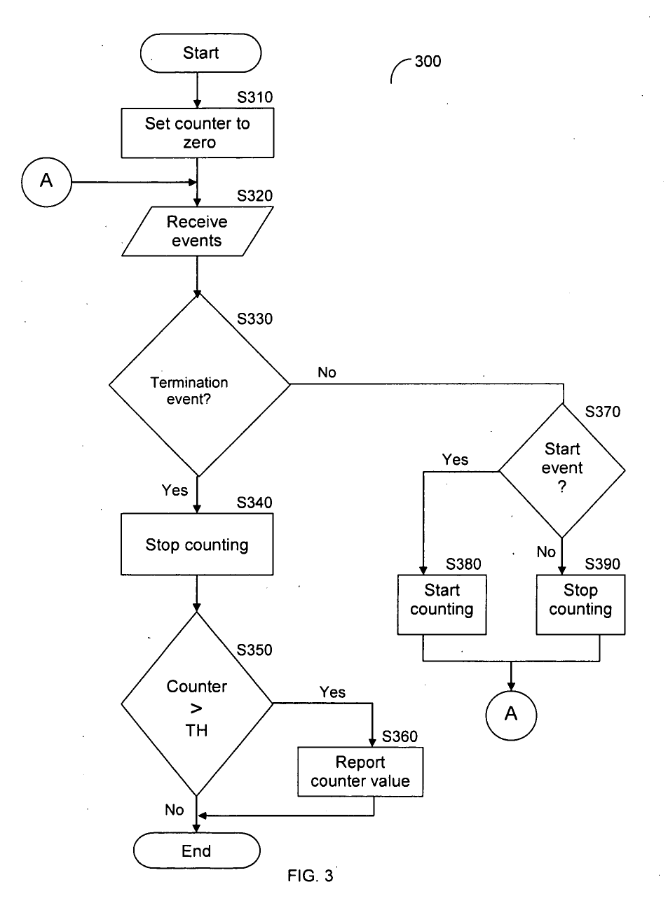

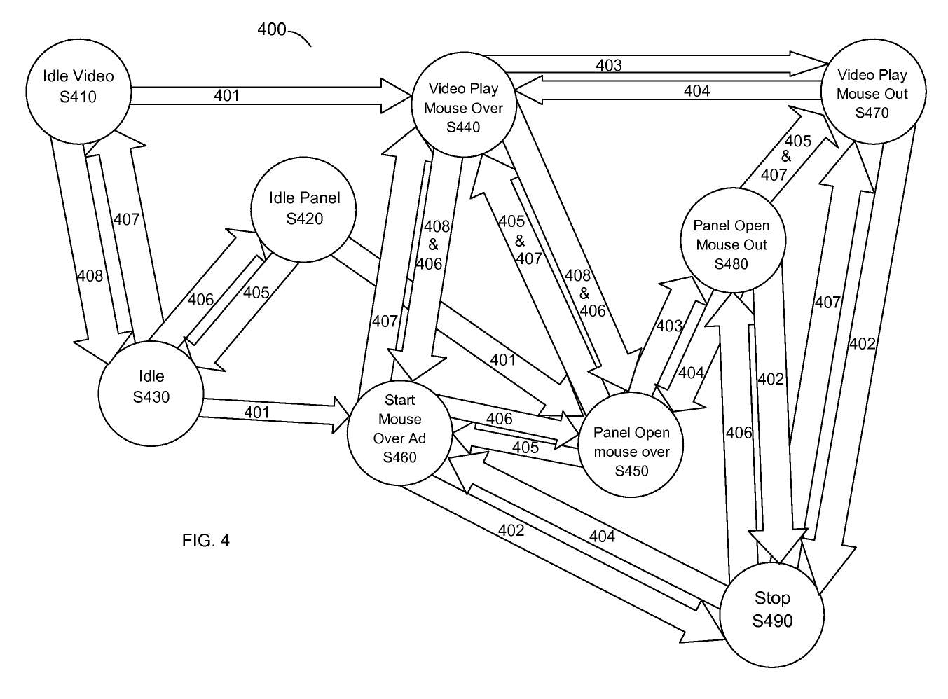

Events collected by event monitors 210 are fed to the dwell controller 220 that executes the tasks of managing the measurement of the dwell time based on collected events. Specifically, the dwell controller 220 instructs the counter 230 whether to start or stop the counting according to the received events, causing the counter to generate a dwell time measure accounting for the total amount of time that a mouse was over an advertisement, user-initiated video duration, user-initiated expansion duration, and any other user-initiated custom interaction duration, such as the duration of a gaming session within the advertisement or the time it takes for a user to fill up a form included in the advertisement. That is, the generated dwell time is a measure of time during which a user interacted with an advertisement. The process carried out by the dwell controller 220 is described in greater detail below with reference to FIGS. 3 and 4.

In the event that the counting is terminated, e.g., the user navigates to a different web page, the value of the counter is determined to be the measured dwell time. Dwell time measures from each client are sent to the database 150 (FIG. 1) and stored therein. The dwell time may be sent together with an identifier (ID) of the online advertisement, an internet protocol (IP) address of a client, an ID of a web page displaying the advertisement, or any other pieces of information that can identify the user, web page and/or the advertisement. In one embodiment, time measures that are below a predefined threshold are not reported.

In accordance with certain exemplary embodiments of the invention a plurality of reports can be generated based on the dwell time measures saved in the database 150. For example, an average dwell time per user, an average dwell time across users, an average dwell time per website, and so on. The reports allow, for example, comparing the exposure time of an advertisement across different websites.

FIG. 3 shows a non-limiting and exemplary flowchart 300 describing a method for measuring online advertisement dwell time implemented in accordance with an embodiment of the invention. In accordance with one embodiment of the invention the method is carried out by the dwell controller 220 and counter 230 shown in FIG. 2.

At S310 the counter 230 is initialized to zero, and thereafter, at S320, the process waits for event(s) to be input from one or more event monitors 210. At S330, upon reception of an event, it is checked if the received event is a termination event, i.e., an event indicating a termination of the measuring process. A termination event maybe, but is not limited, moving a pointing device out of the advertisement's area, closing the browser, navigating to a different web page, the counter exceeds a predefined time threshold and a timeout mechanism was activated, and so on. If S330 results with a Yes answer, execution continues with S340 where the counter 230 is instructed to stop the counting (if the counter is active); otherwise, execution continues with S370.

At S350 it is checked if the value of the counter is greater than a predefined amount of time (e.g., 1 second), and if so at S360 the value of the counter, i.e., the measured dwell time is logged and sent to an external database (e.g., database 150); otherwise, execution ends. It should be noted that step S350 may be used as a filter for filtering values that cannot be considered as real user interaction with the advertisement. For example, if the user accidently crossed over the advertisement with the pointing device, such event may trigger the measuring process, but eventually will not be reported.

At S370 it is checked if an event received at S320 is a “start event”, i.e., an event that should trigger the counting, and if so, at S380, the counter is instructed to run the count; otherwise, at S390 the counter is instructed to stop the count. An exemplary state machine utilized to perform steps S370, S380, and S390 is shown in FIG. 4. After instructing the counter, execution returns to S320. As mentioned above, the events are associated with the different states of rich media objects in the advertisement.

FIG. 4 shows an exemplary and non-limiting diagram 400 of a state machine showing how different events control the measurement of online advertisement dwell time implemented in accordance with an embodiment of the invention. In accordance with certain exemplary embodiments of the invention, the following events are monitored: the location of a pointing device on the webpage with respect to the advertisement, the state of a video clip being played in the advertisement, and the state of a panel in the advertisement. Arrows labeled as 401, 402, 403, 404, 405, 406, 407, and 408 respectively represent the following events: start, stop, pointing device out, pointing device over the advertisement, panel closed, panel opened, video playing, and video stopped.

States S410 and S420 indicate that the video and panel are idle and the counting is also in an idle state (S430), as the pointing device is not over the online advertisement for more than a predefined amount of time. Once the pointing device is detected as being over the advertisement for a predefined duration a start event 401 is generated to trigger the counting. From states S410, S420 and S430 there is a transit to a counting state S440, S450 and S460 respectively. Events 402 will cause to stop the counting. An event 402 is generated when the rich media objects (video and panel) are inactive and the pointing device is out of the online advertisement (i.e., transition from S460 to S490); when the video clip being played in the advertisement is stopped and no panels are opened (i.e., transition from S470 to S490); or when all panels are closed and no video clip is being played (i.e., transition from S480 to S490).

As can be derived from the state machine diagram 400 the events that start and stop the counting are based on an interaction from the user, i.e., play/play video and open/close panel, thereby the dwell time is measured to account for the time that a user interacts with the advertisement. As can be further derived from the state machine depicted in FIG. 4, the dwell time measurement can be applied to special types of advertisements. Following are a few non-limiting examples: for an advertisement in a format of an expandable banner with a video clip played in a panel, the counter keeps counting, until the panel is closed, i.e., even when the pointing device is outside of the panel. If the panel is not auto retract and the video clip has ended, the counter continues its counting until the panel is closed.

As another example an advertisement in a format of a rich banner that plays a video clip in a loop, once the pointing device crossed over the banner, the measuring of the dwell time begins. If a user interacted with the advertisement anytime before the video clip starts, the video clip's duration is added to the timer, even if the pointing device was out of the advertisement when the video clip was played.

The principles of the invention can be implemented as hardware, firmware, software or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What we claim is:

1. A method for measuring online advertisement dwell time, wherein the method is performed by a client device adapted to download a webpage that includes the online advertisement, comprising:
monitoring a plurality of events being generated in a response to a user interaction with the online advertisement embedded in the webpage;
determining at least a type of each event being monitored;
instructing a counter adapted to count the dwell time to perform at least terminating the counting, starting the counting or stopping the counting; and
recording a value of the counter as a measured dwell time, upon termination of the counting.

2. The method of claim 1, wherein the plurality of events are associated with at least the user interaction with rich media objects included in the online advertisement.

3. The method of claim 2, wherein the plurality of events being monitored are at least one of: a location of a pointing device on the webpage with respect to the online advertisement, a state of a video clip being played in the online advertisement, and a state of a panel in the online advertisement.

4. The method of claim 3, wherein the counter is instructed to start the counting when the following conditions are satisfied:
the pointing device is placed over the online advertisement for a predefined duration of time; and
at least one of the video clip event and the panel event is active, wherein an active video clip event indicates that a video clip is being played in the online advertisement and an active panel event indicates that at least one panel is open in the online advertisement.

5. The method of claim 3, wherein the counter is instructed to stop the counting when the following conditions are satisfied:
the pointing device does not point to the online advertisement; and
at least one of the video clip event and the panel event is inactive, wherein an inactive video clip event indicates that a video clip was stopped playing and an inactive panel event indicates that all panels are closed.

6. The method of claim 3, wherein the counter is instructed to stop the counting when at least one the following condition is satisfied:
the video clip event and the panel event is inactive.

7. The method of claim 3, wherein the counter is instructed to terminate the counting when at least one of the following conditions is satisfied:
a pointing device does not point to the online advertisement, a web browser was closed, a user navigates to a different web page, and the counter exceeds a predefined time threshold and a timeout mechanism was activated.

8. The method of claim 1, wherein recording the value of the counter as a measured dwell time further comprising:
recording the measured dwell time when the value of the counter is above a predefined time threshold.

9. The method of claim 1, further comprising generating a plurality of statistical reports based on the measured dwell time, wherein the statistical reports allow for comparing at least an exposure time of the online advertisement across different websites.

10. The method of claim 9, wherein the plurality of statistical reports include at least one of: an average dwell time per user, an average dwell time across users, and an average dwell time per website.

11. A computer readable medium having stored thereon computer executable code when executed by a client causing the client to perform the process of measuring online advertisement dwell time, wherein the client adapted to download a webpage that includes the online advertisement the client comprises at least a processor and the readable medium, the process comprising:
monitoring a plurality of events being generated in a response to a user interaction with the online advertisement embedded in the webpage;
determining at least a type of each event being monitored;
instructing a counter adapted to count the dwell time to perform at least terminating the counting, starting the counting or stopping the counting; and
recording a value of the counter and reporting the value as the measured dwell time, upon termination of the counting.

12. A dwell counter for measuring online advertisement dwell time, comprising:
a plurality of event monitors for monitoring and capturing events associated with a user interaction with one or more rich-media objects of the online advertisement;
a dwell controller for instructing a counter to perform at least terminating the counting, starting the counting or stopping the counting; and
a counter for counting the dwell time based on instructions received from the dwell controller.

13. The dwell counter of claim 12, which is further capable of:
upon termination of the counting, recoding a value of the counter and reporting the value as the measured dwell time when the value of the counter is above a predefined time threshold.

14. The dwell counter of claim 12, wherein the plurality of events are at least one of: a location of a pointing device on the webpage with respect to the online advertisement, a state of a video clip being played in the online advertisement, and a state of one or more panels in the online advertisement.

15. The dwell counter of claim 14, wherein the counter is instructed to start the counting when the following conditions are satisfied:
the pointing device is placed over the online advertisement for a predefined duration of time; and
at least one of the video clip event and the panel event is active, wherein an active video clip event indicates that a video clip is being played in the online advertisement and an active panel event indicates that the panel is open in the online advertisement.

16. The dwell counter of claim 14, wherein the counter is instructed to stop the counting when the following conditions are satisfied:
the pointing device does not point to the online advertisement; and
at least one of the video clip event and the panel event is inactive, wherein an inactive video clip event indicates that no panels are opened and an inactive panel event indicates that the panel are closed.

17. The dwell counter of claim 14, wherein the counter is instructed to stop the counting when at least one the following conditions are satisfied:
the video clip event and the panel event are inactive.

18. The dwell counter of claim 14, wherein the counter is instructed to terminate the counting when at least one of the following conditions is satisfied:
a pointing device does not point to the online advertisement, a web browser was closed, a user navigates to a different web page, and the counter exceeds a predefined time threshold and a timeout mechanism was activated.

19. The dwell counter of claim 14, is further capable of generating a plurality of statistical reports based on the measured dwell time, wherein the statistical reports allow for comparing at least an exposure time of the online advertisement across different websites.

20. The dwell counter of claim 19, wherein the plurality of statistical reports include at least one of: an average dwell time per user, an average dwell time across users, and an average dwell time per website.
